(19) United States
(12) Patent Application Publication
(10) Pub. No.: US 2021/0294314 A1
(43) Pub. Date: Sep. 23, 2021

(54) SYSTEM FOR PROCESSING DEVICE PARTS OF SIMULATED SMOKING DEVICES

(71) Applicant: Sluis Cigar Machinery B.V., Kampen (NL)

(72) Inventor: Oscar SLURINK, Heino (NL)

(73) Assignee: Sluis Cigar Machinery B.V., Kampen (NL)

(21) Appl. No.: 17/261,537

(22) PCT Filed: Jul. 19, 2019
(86) PCT No.: PCT/NL2019/050466

§ 371 Date: Jan. 19, 2021

(30) Foreign Application Priority Data
Jul. 19, 2018 (NL) 2021349

(51) Int. Cl. G05B 19/418; A24F 40/70; A24F 40/80; A24F 40/42; A24F 40/10; B65B 3/28; B65B 57/10

(52) U.S. Cl. CPC G05B 19/41875; G05B 19/4189; A24F 40/70; A24F 40/80; G05B 2219/32128; A24F 40/10; B65B 3/28; B65B 57/10; G05B 2219/39466; A24F 40/42

(57) ABSTRACT

A system for processing device parts of simulated smoking devices, such as cartridges of electronic cigarettes, said system comprising a processing station to perform a processing operation on each of the device parts of a batch of device parts, which batch has a batch number of device parts being larger than one, an evaluation station to evaluate the result of the processing operation on each device part of the batch, which evaluation station is configured to provide an evaluation signal for each device part of the batch, a transport device to move the device parts of the batch along a production trajectory, which production trajectory extends through the processing station, the evaluation station and an isolating station, and a controller which is in communication with the evaluation station and the isolating station.

### FIELD OF THE INVENTION

The invention relates to a system for processing device parts of simulated smoking devices, such as cartridges of electronic cigarettes. The system may comprise a processing station, an evaluation station, a transporter and a controller.

### BACKGROUND OF THE INVENTION

The invention is based on the insight that in practice the processing station and/or the evaluation station may not always function correctly. Therefore, there is a need to determine if the processing and/or the evaluation station function correctly.

### SUMMARY OF THE INVENTION

The invention has the objective to provide an improved or at least alternative processing device parts of simulated smoking devices.

This objective is reached by a system for processing device parts of simulated smoking devices, such as cartridges of electronic cigarettes, said system comprising;
a processing station to perform a processing operation on each of the device parts of a batch of device parts, which batch has a batch number of device parts being larger than one,
an evaluation station to evaluate the result of the processing operation on each device part of the batch, which evaluation station is configured to provide an evaluation signal for each device part of the batch,
a transport device to move the device parts of the batch along a production trajectory, which production trajectory extends through the processing station, the evaluation station and an isolating station,
a controller which is in communication with the evaluation station and the isolating station, wherein:
   the transport device is configured to position the processed device parts of the batch in an isolating number of isolating positions located in an isolating trajectory part of the production trajectory, which isolating trajectory part extends through the isolating station,
   the isolating station comprises a gripper having gripping members defining a gripping number of gripping positions of the gripper,
   the gripper is configured to grip with the gripping members device parts located in the gripping positions,
   the isolating station comprises a gripper mover configured to move the gripper from an engaging position into a rejecting position, and vice versa,
   in the engaging position of the gripper, the device parts of the batch located in the isolating positions are also located in the gripping positions of the gripper,
   the rejecting position of the gripper is located at a rejecting distance from the engaging position and allows the gripper to discharge gripped device parts into a rejection area,
   the controller is configured to determine on the basis of the evaluation signals on which of the device parts of the batch located in the isolating positions the processing station has not correctly carried out the processing operation,
   the isolating station is configured to grip with the gripper and based on the determination of the controller one or more device parts of the batch located in the isolating positions on which the processing operation has not been carried out correctly by the processing station and to discharge said gripped one or more device parts into the rejection area,
   the gripper mover is configured to also move the gripper from the engaging position into a testing position, and vice versa,
   the testing position is located at a sample distance from the engaging position and differs from the rejecting position,
   the system comprises a user interface allowing a user to select one of the device parts of the batch, which user interface is in communication with the controller and configured to provide a selection signal,
   the controller is configured to determine on the basis of the selection signal which one of the device parts of the batch has been selected via the user interface,
   the isolating station is configured to grip with the gripper and based on the determination of the controller the one of the device parts of the batch being selected via the user interface and located in one of the isolating positions in order to positon said gripped device part in a sample position.

The isolating station does not only allow that device parts on which the processing operation has not been carried out correctly are rejected, but also that a sample can be taken to independently check if the processing station and the evaluation station are operating correctly. The isolating station allows this in an efficient manner while having a simple construction. In addition, it is also possible to check the sample which has been taken by the isolating station on other characteristics.

In an embodiment of the system, the gripper is configured to position the gripped device part being selected via the user interface in the sample position while the gripper is positioned in the testing position.

In an embodiment of the system, the controller is in communication with the transport device, one of the isolating positions defines a predetermined selecting position, the controller and the transport device are configured to position the one of the device parts being selected via the user interface in the predetermined selecting position, the isolating station is configured to grip with the gripper the one of the device parts of the batch located in the predetermined selecting position and being selected via the user interface in order to positon said gripped device part in the sample area.

In an embodiment of the system, the directions of movement of the gripper between and into the engaging position and the rejecting position and between and into the engaging position and the testing position all extend in a virtual flat plane.

In an embodiment of the system, the engaging position, the rejecting position, the engaging position and the sample position are located in the virtual flat plane

In an embodiment of the system, the virtual flat plane is located at a fixed position along the production trajectory.

In an embodiment of the system, the transport device is configured to hold the device parts of the batch during the movement along the production trajectory in a predetermined orientation, such as in an upright orientation.

In an embodiment of the system, the gripper is configured to hold the gripped device parts located in the gripping positions in the predetermined orientation.

In an embodiment of the system, the gripper mover is configured to move the gripper between the engaging position and the testing position while keeping the gripped device part located in the gripping position and being selected via the user interface in the predetermined orientation.

In an embodiment of the system, the gripper mover is configured to, when located in the testing position, position the gripped device part located in the gripping position and being selected via the user interface in the sample position while keeping said device part in the predetermined orientation.

In an embodiment of the system, the gripper mover is configured to move the gripper between the engaging position and the rejecting position while keeping the gripped device parts located in the gripping positions in the predetermined orientation.

In an embodiment of the system, the system comprises a sample device having a part holder to hold one of the device parts, the sample device is configured to move the part holder from a retracted position into an extended position, and vice versa, the sample position is defined by the part holder located in the retracted position, the system comprises a safety cover forming a safety boundary between a system area in which the transport device, the processing station, the evaluation station, and the isolating station are located, and a user area, the safety cover comprises a sample opening through which the sample device extends, and the part holder located in the retracted position is located in the system area and the part holder located in the extended position is located in the user area.

In an embodiment of the system, the part holder is configured to hold the device part in the predetermined orientation.

In an embodiment of the system, the sample device is configured to move the part holder from the retracted position into the extended position while keeping the device part held by the part holder in the predetermined orientation.

In an embodiment of the system, each gripping position of the gripper is located between one of the gripping members and an associated support surface, and each gripping member comprises a pushing surface which is movable from a receiving position at a receiving distance from its associated support surface into a pushing position at a smaller pushing distance from its associated support surface, and vice versa.

In an embodiment of the system, the gripper is configured to receive the device parts of the batch located in the isolating positions when the pushing surfaces of the gripping members are located in the receiving position and to grip the device parts of the batch located in the isolating positions when the pushing surfaces of the gripping members are located in the pushing position.

In an embodiment of the system, the gripper is configured to clamp device parts between gripping members with the pushing surfaces located in the pushing position and the associated support surfaces.

In an embodiment of the system, the associated support surfaces partly surround the device parts.

In an embodiment of the system, each gripping member comprises a bellow having an exterior surface which forms the pushing surface of said gripping member, the system comprises a fluid pressure device connected to the bellows to individually adjust a fluid pressure in the bellows in order to move the pushing surfaces of the bellows from the receiving position into the pushing position, and vice versa, and the fluid pressure device is controlled by the controller.

In an embodiment of the system, the transport device moves the device parts along the production trajectory in an intermittent manner.

In an embodiment of the system, the intermittent manner in which transport device moves the device parts along the production trajectory corresponding to the batch number of the batch of device parts.

In an embodiment of the system, the isolating number of the isolating positions corresponds to the batch number of the batch of device parts, and the gripping number of the gripping positions of the gripper corresponds to the isolating number.

In an embodiment of the system, the processing station is a filling station to discharge a predetermined amount of fluid in each of the device parts of the batch of device parts, and the evaluation station is configured to check a filling characteristic of each device part of the batch.

In an embodiment of the system, the evaluation station is a weighing station to individually weigh the device parts filled by the filling station, which weighing station provides a measurement signal for each of the device parts, and the controller is configured to determine if the predetermined amount of fluid has been discharged in each of the device parts on the basis of the measurement signals.

In an embodiment of the system, the device parts of the batch comprise a fluid chamber to hold the fluid and a filling opening having an open connection with the fluid chamber and an surrounding area of said device parts.

In an embodiment of the system, the filling opening is located at an upper part of the device part.

In an embodiment of the system, the isolating station is configured to grip with the gripper only one or more device parts of the batch located in the isolating positions on which the processing operation has not been carried out correctly by the processing station or only the one of the device parts of the batch being selected via the user interface and located in one of the isolating positions, and the transport device is configured to move the device parts which are not gripped by the gripper further along the production trajectory.

### BRIEF DESCRIPTION OF THE INVENTION

Embodiments of the system according to the invention will be described by way of example only, with reference to the accompanying schematic drawings in which corresponding reference symbols indicate corresponding parts, and in which:

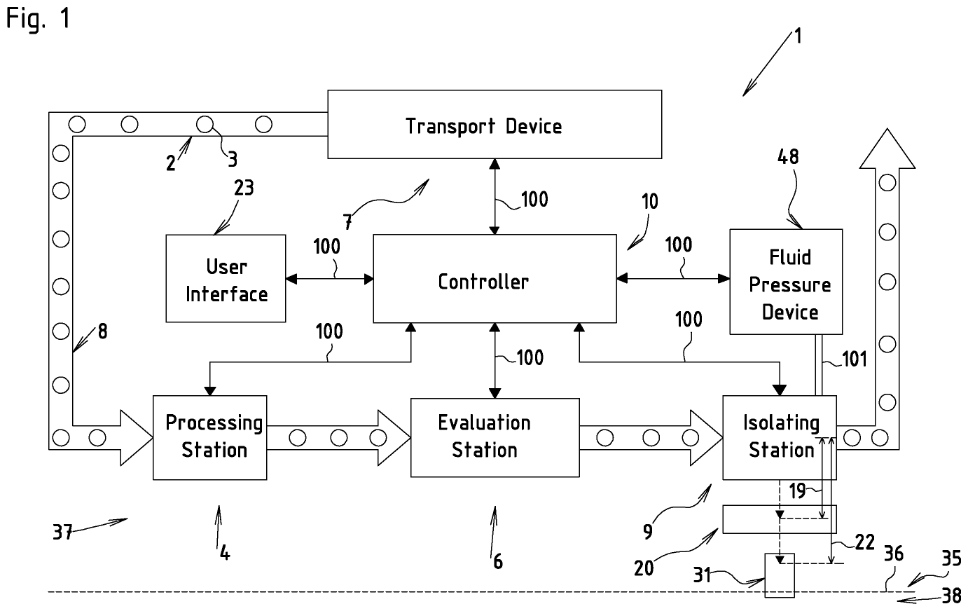

FIG. 1 schematically shows a general representation of an embodiment of the system according to the invention,

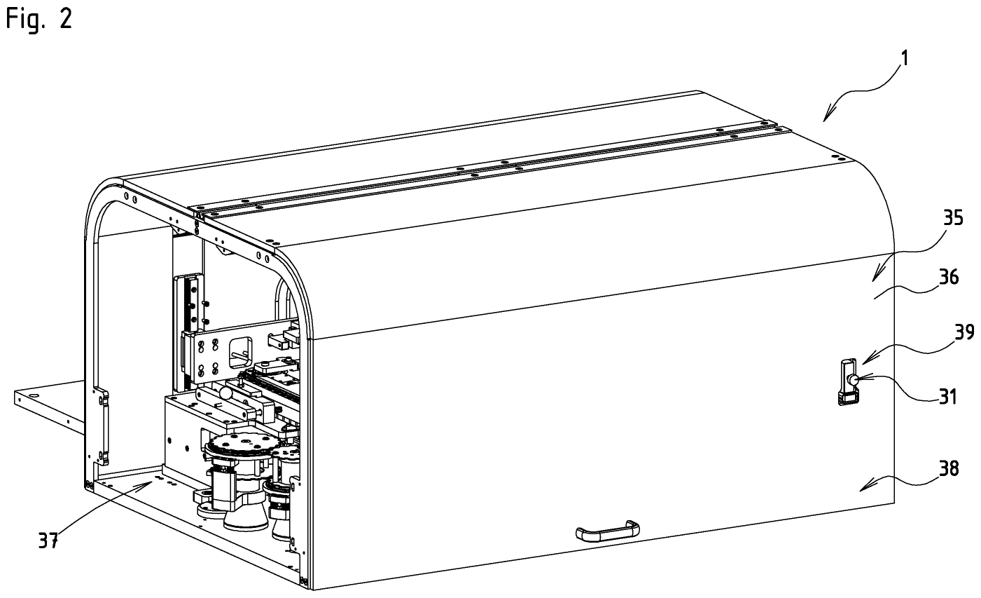

FIG. 2 schematically shows a view in perspective of the system of FIG. 1,

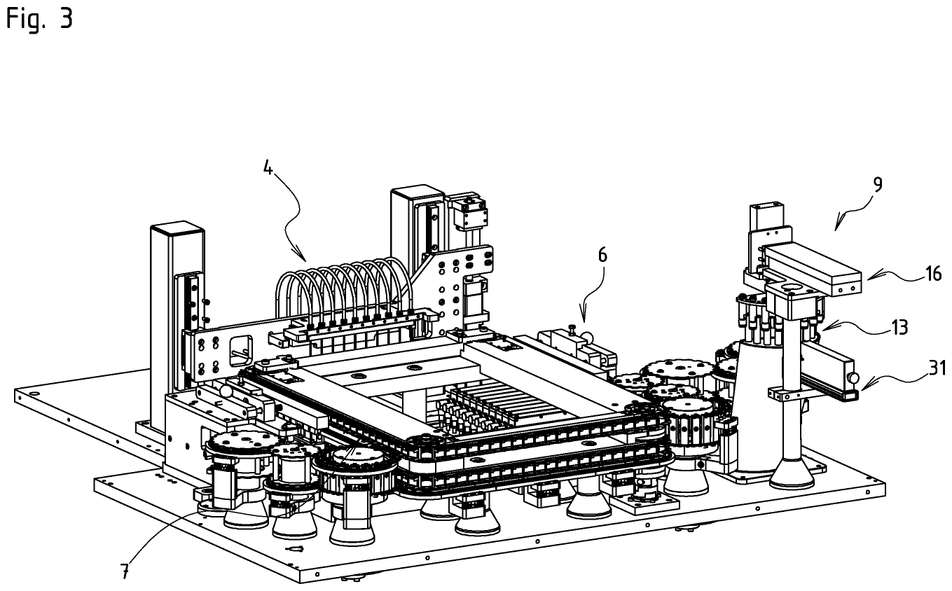

FIG. 3 schematically shows the view of FIG. 1 without the safety cover,

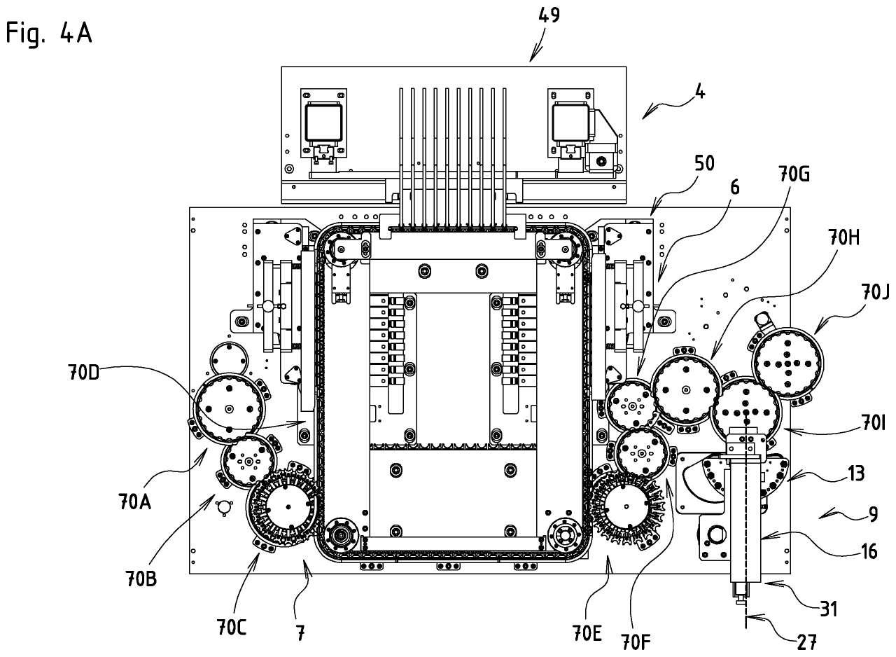

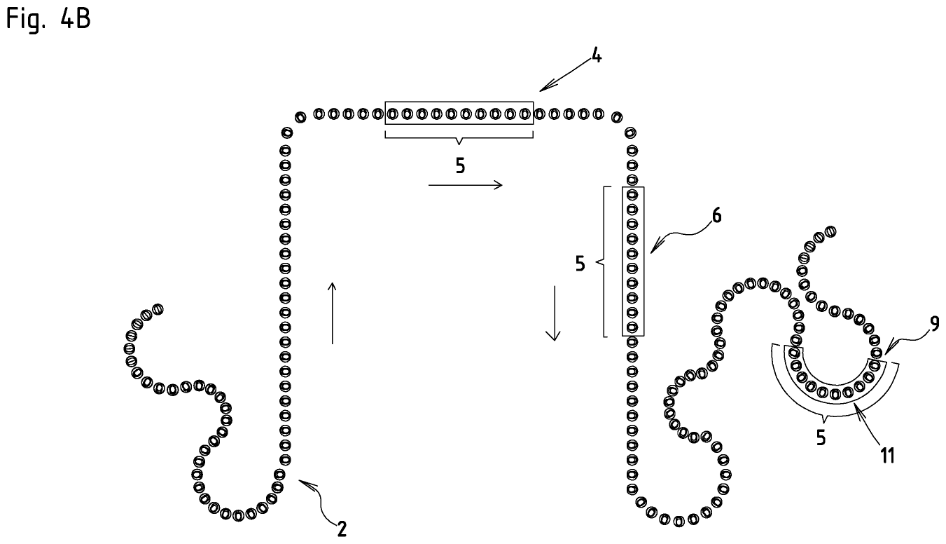

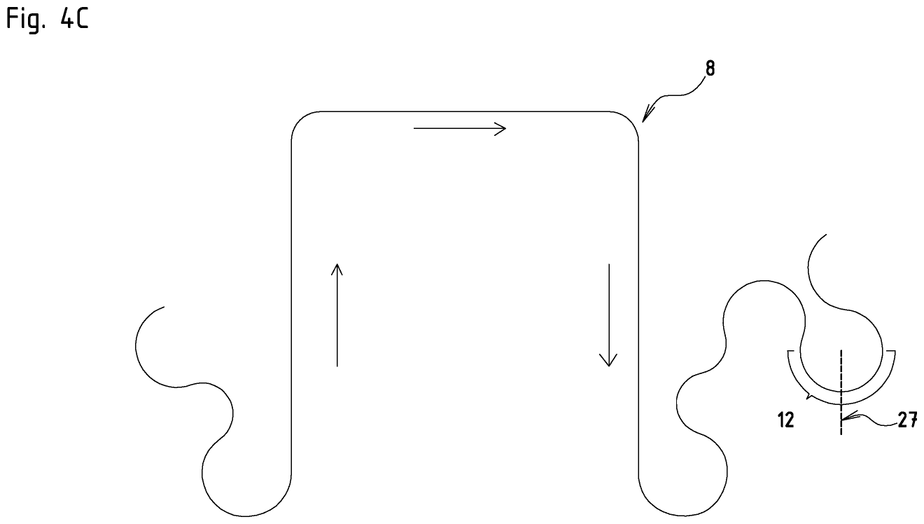

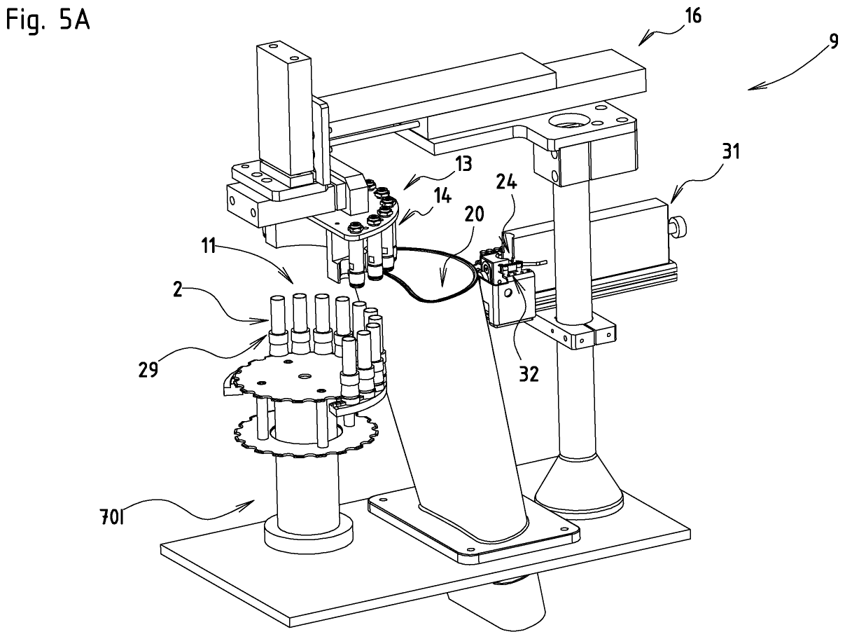

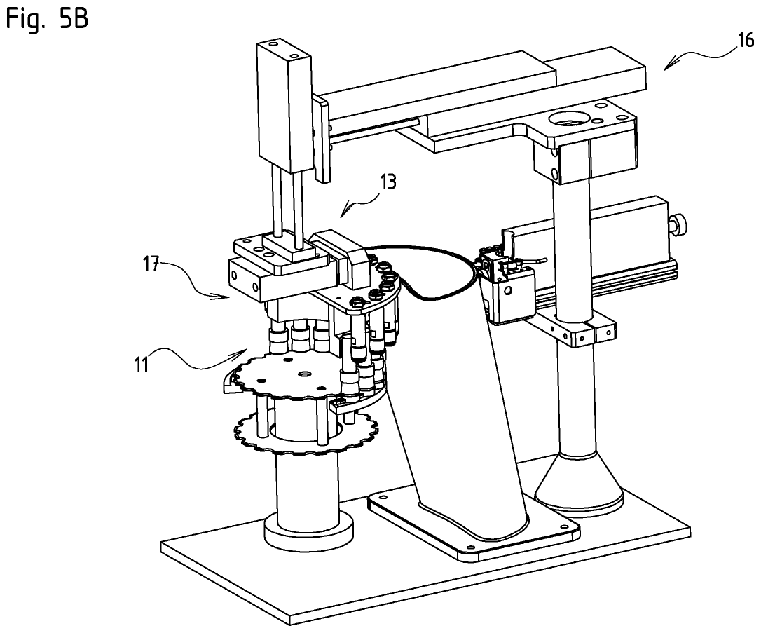

the FIGS. 4A-C schematically show top views of the system of FIG. 1,

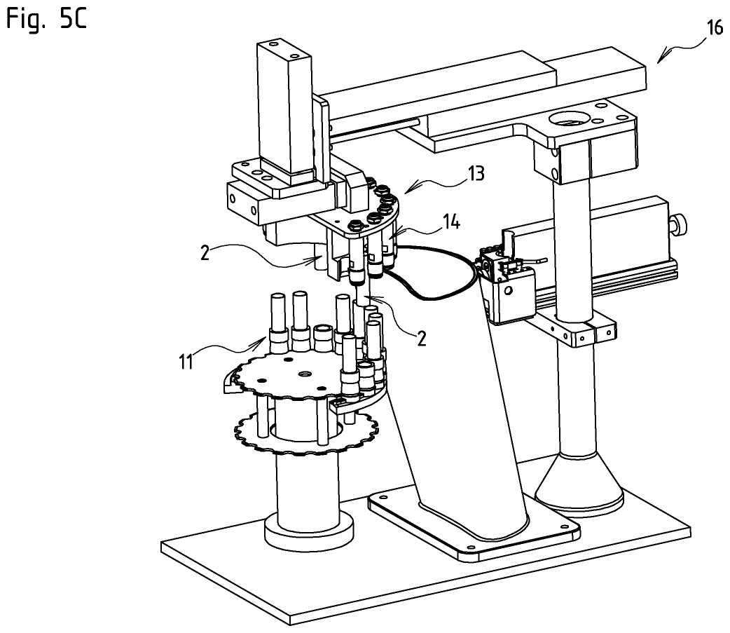

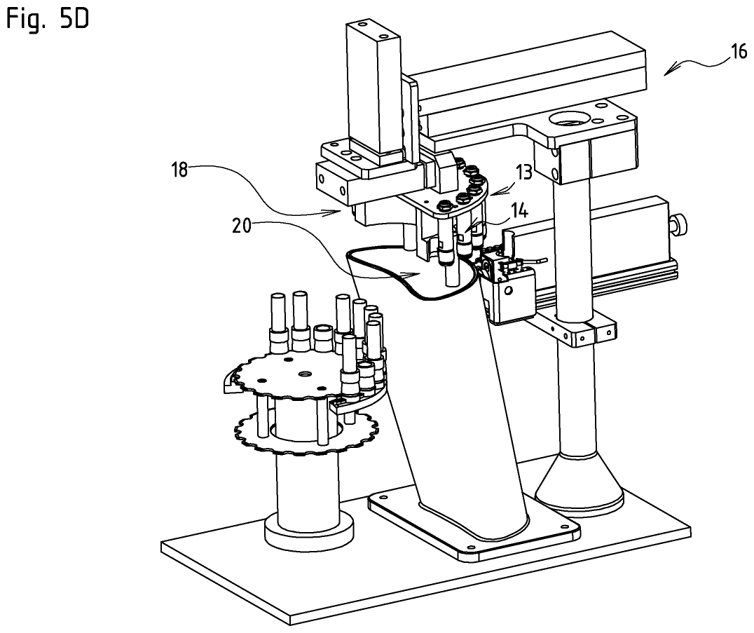

the FIGS. 5A-D schematically show views in perspective of the isolating station of the system of FIG. 1,

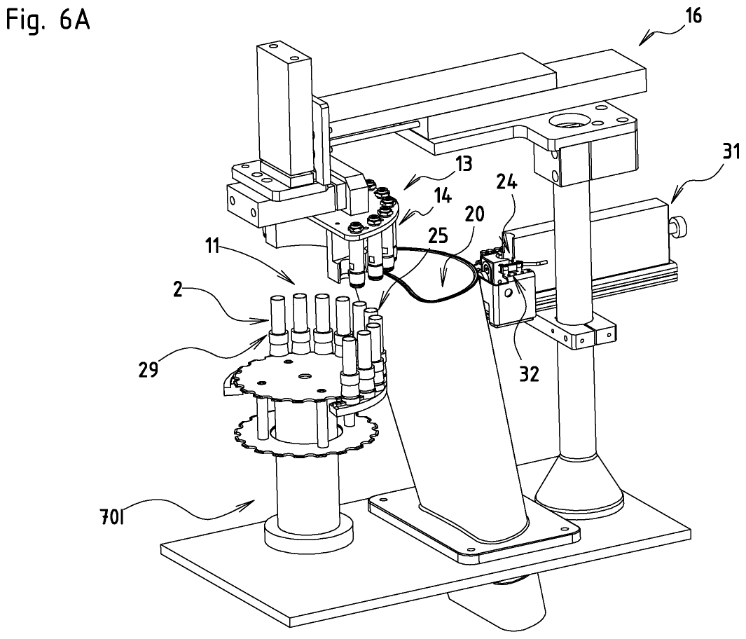

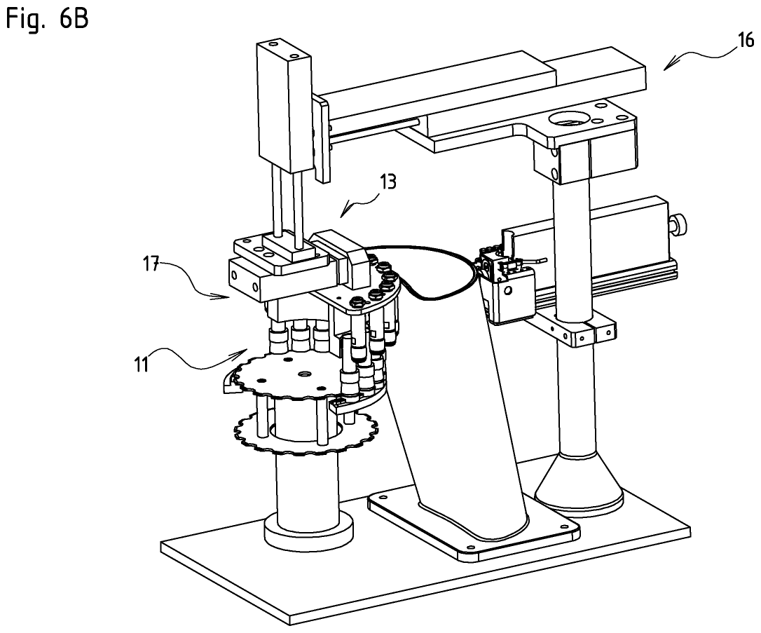

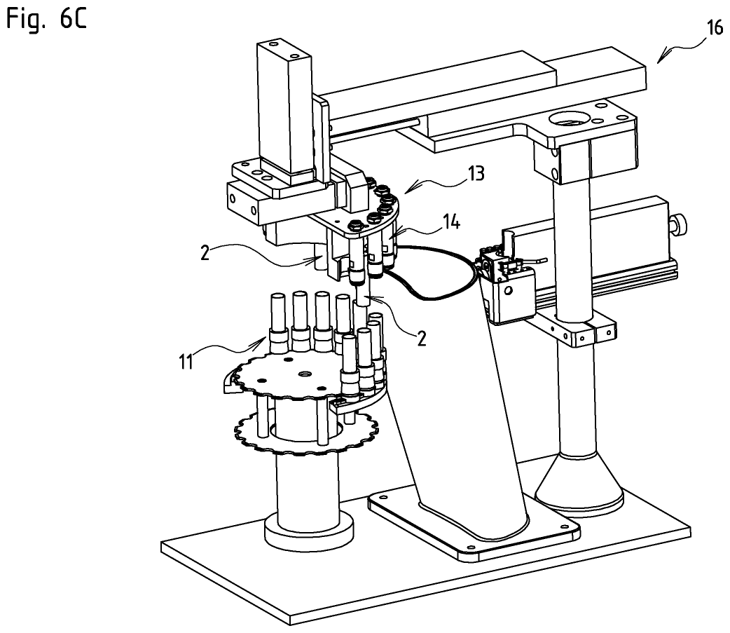

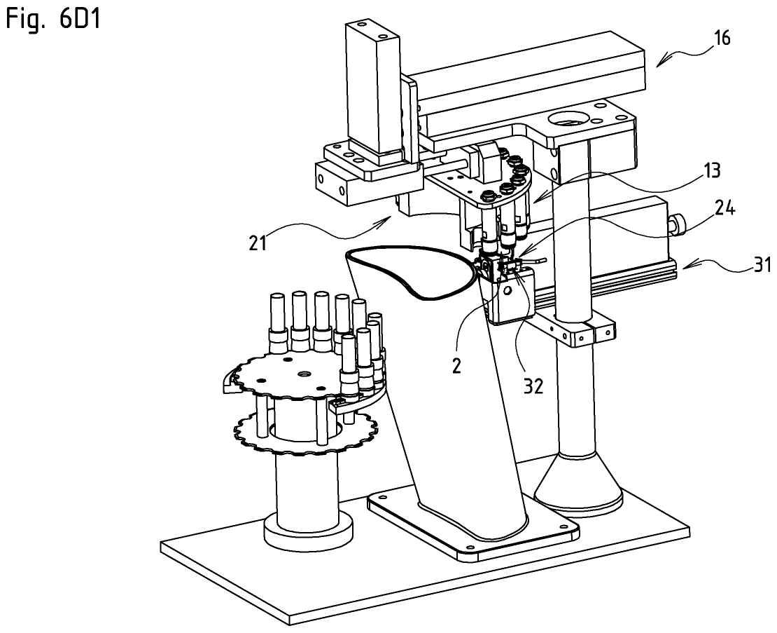

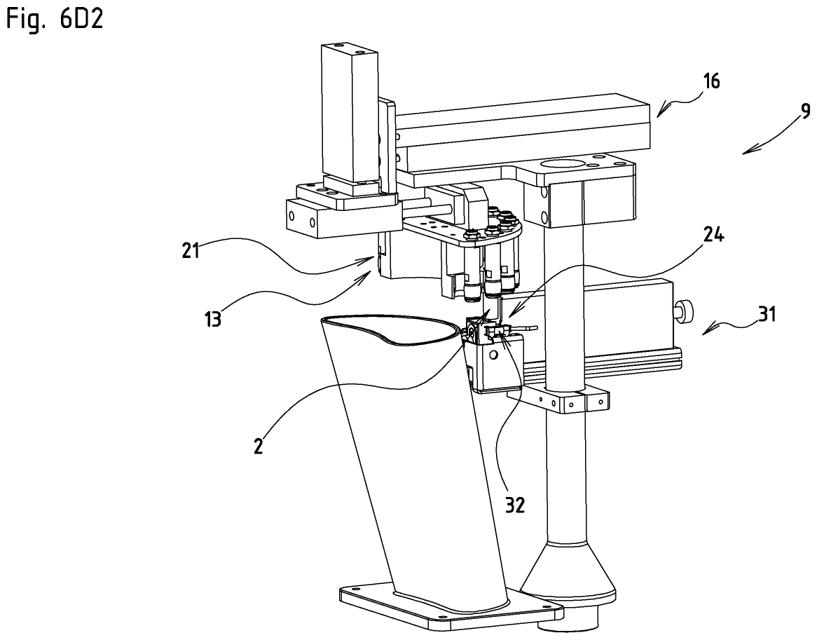

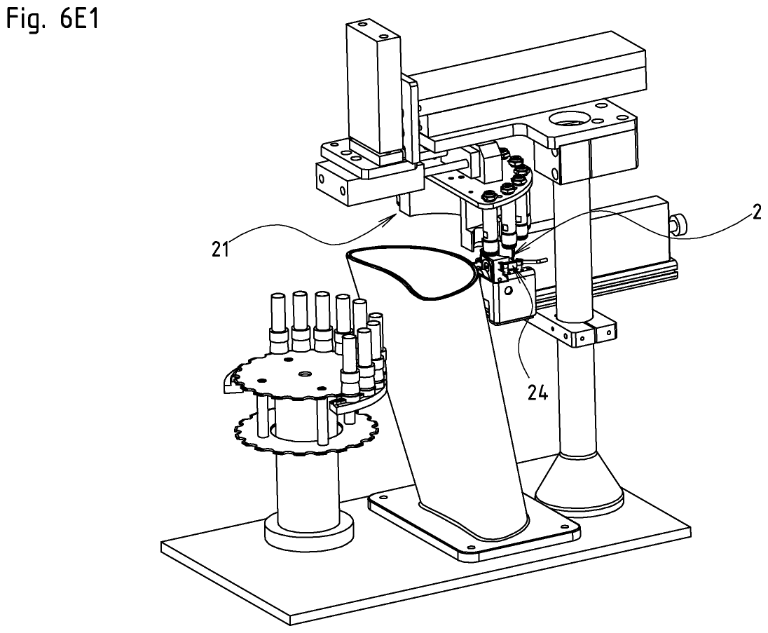

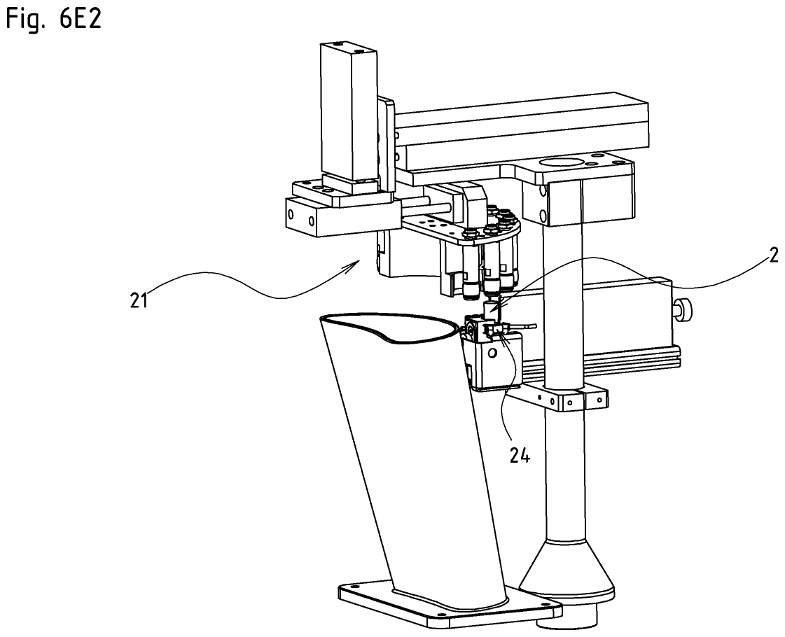

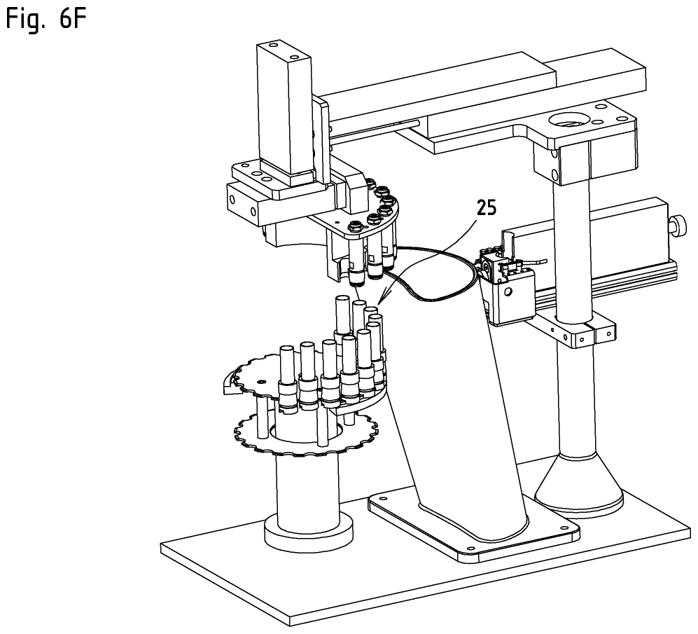

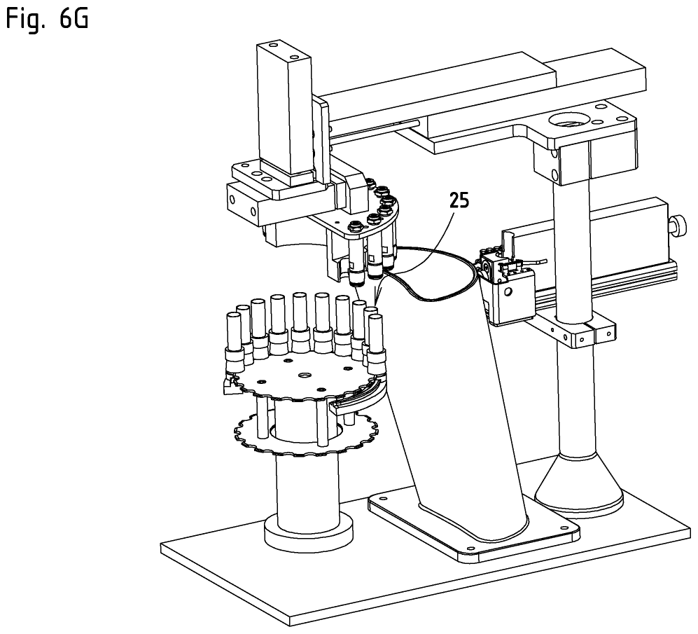

the FIGS. 6A-G schematically show views in perspective of the isolating station of the system of FIG. 1,

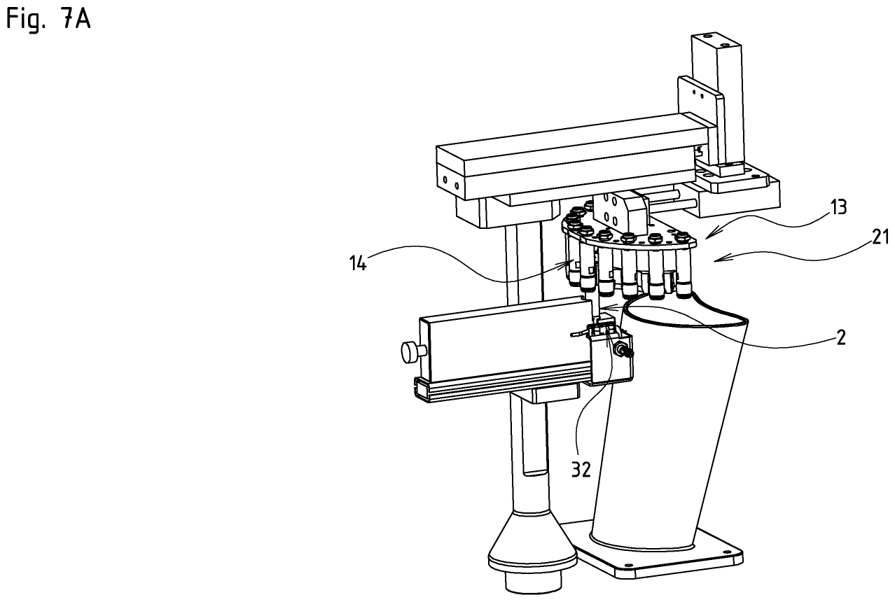

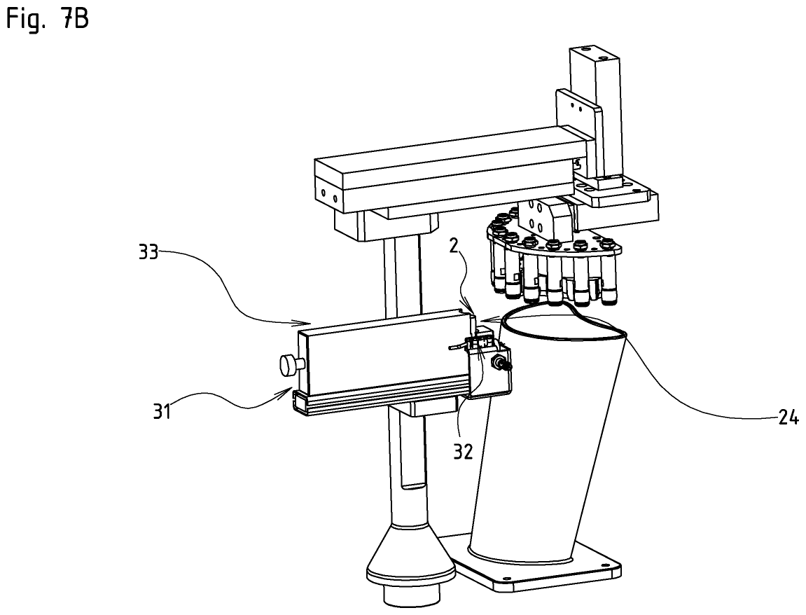

the FIGS. 7A-C schematically show views in perspective of the sample device of the system of FIG. 1,

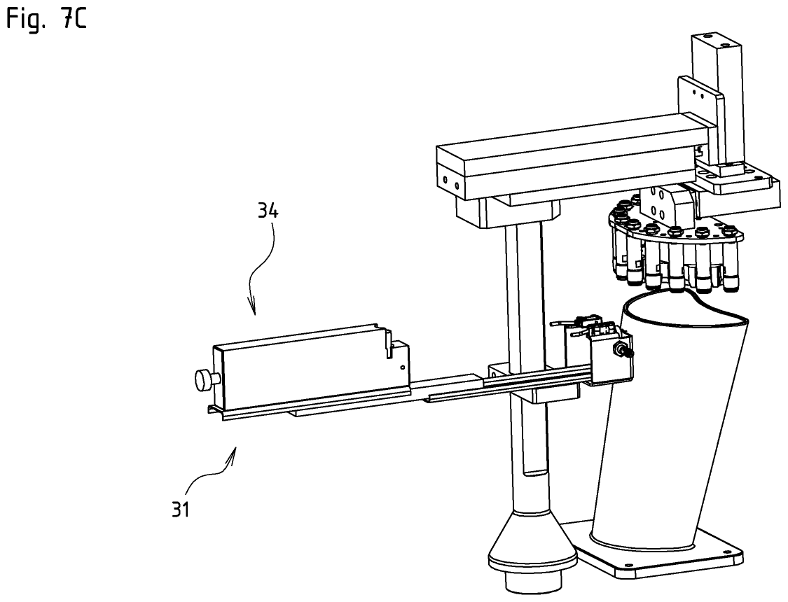

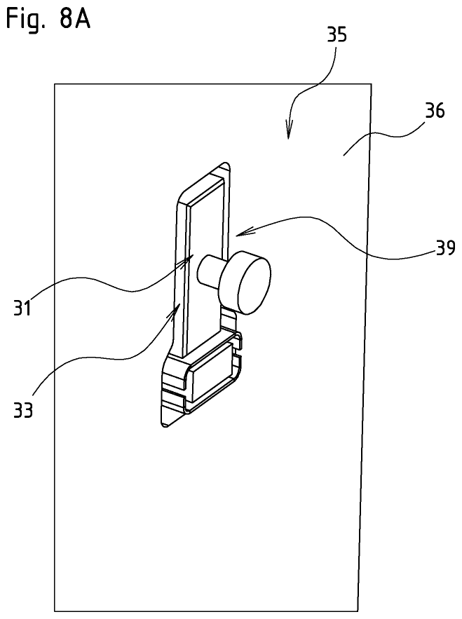

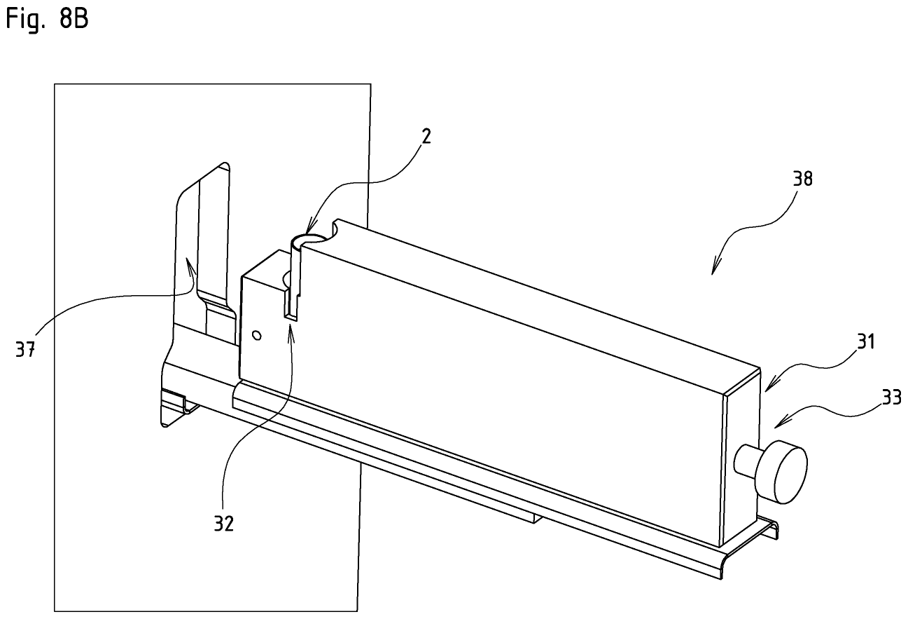

the FIGS. 8A-B schematically show views in perspective of the sample device of the system of FIG. 1,

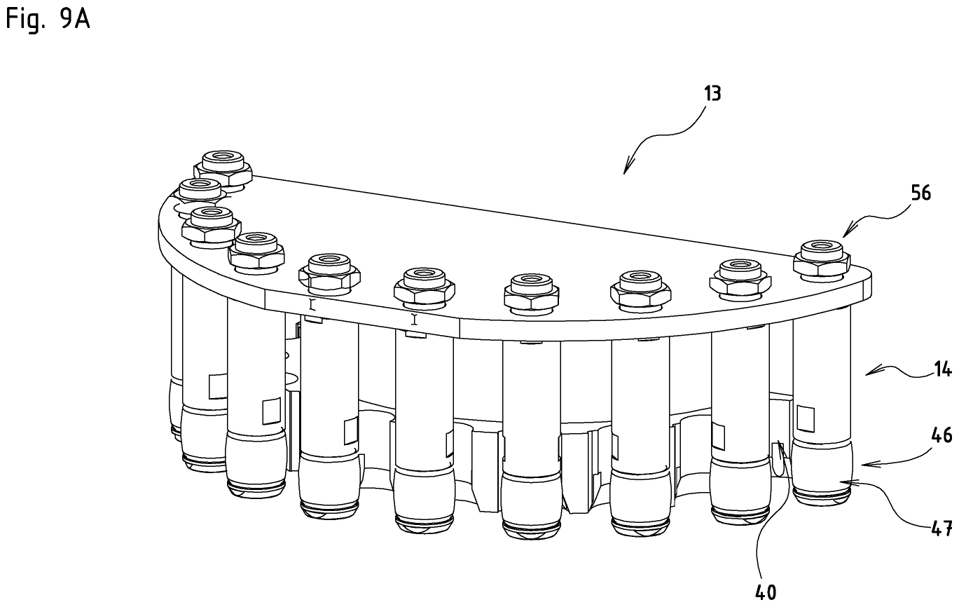

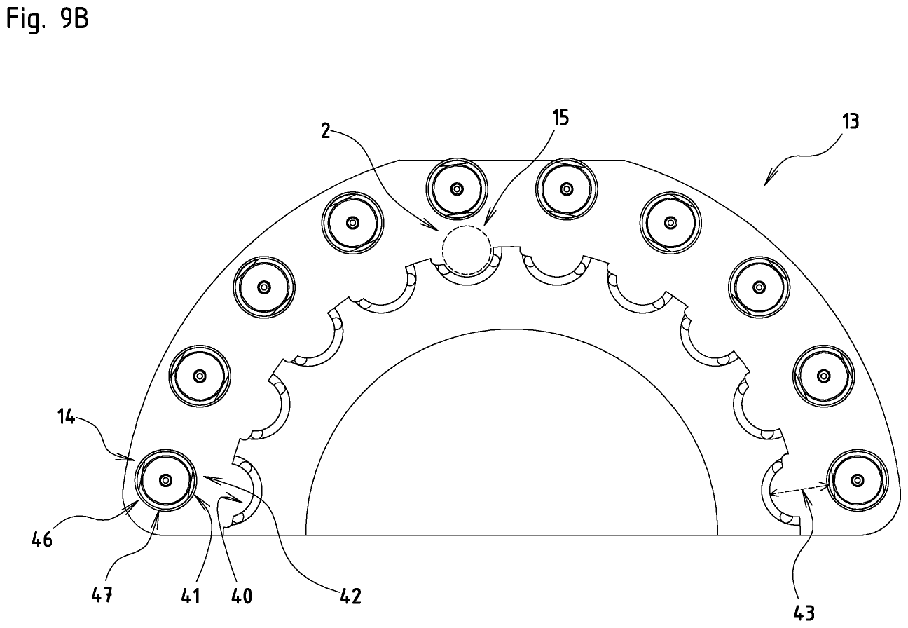

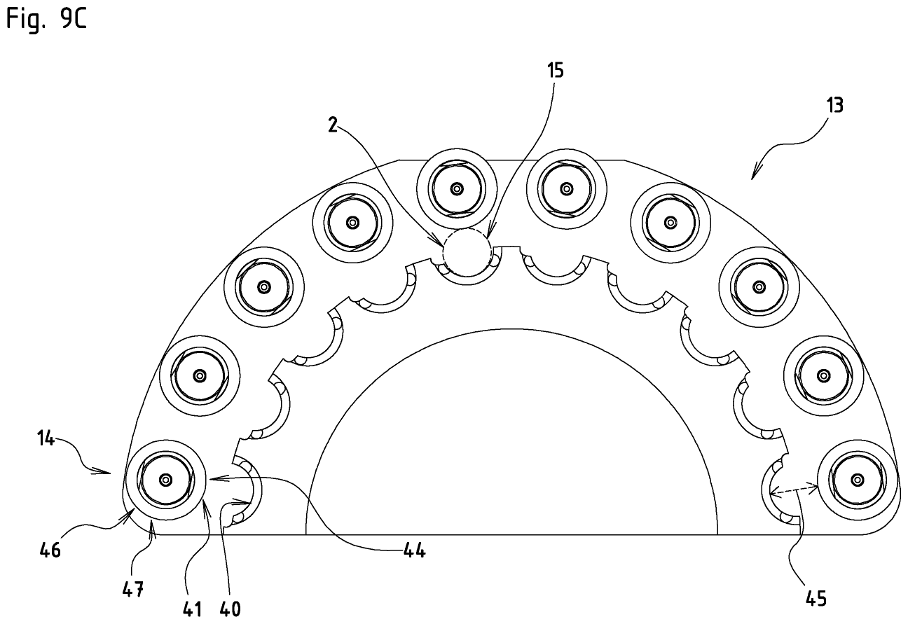

FIG. 9A schematically shows a view in perspective of the gripper of the system of FIG. 1,

the FIGS. 9B-C schematically show bottom view of the gripper of FIG. 9A,

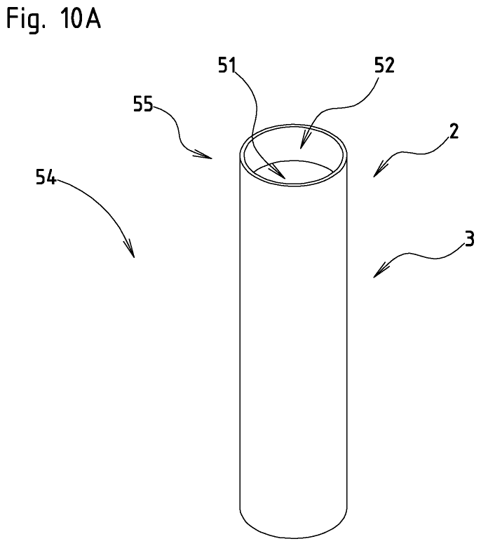

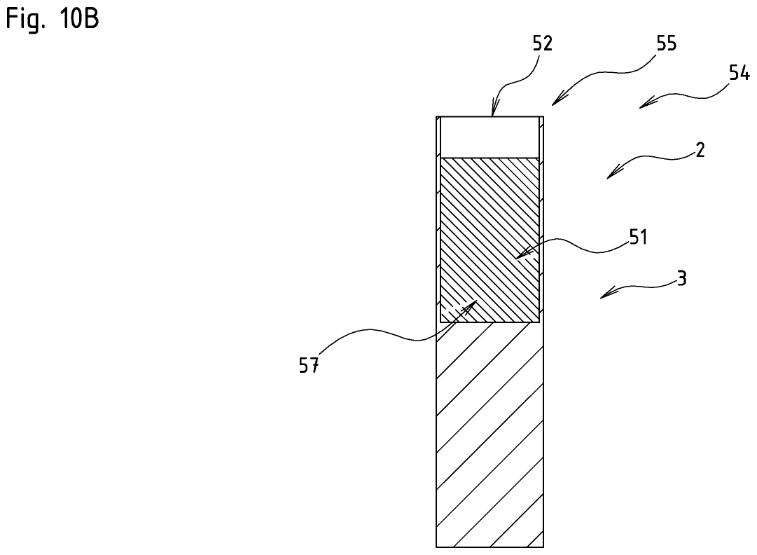

FIG. 10A schematically shows a view in perspective of the device part of the system of FIG. 1, and

FIG. 10B schematically shows a view in cross section of the device part of FIG. 10A.

### DETAILED DESCRIPTION OF THE INVENTION

FIG. 1 shows a general representation of an embodiment of the system 1 according to the invention. The system 1 will be explained in relation to the general representation with references to more detailed figures.

The system 1 is configured to process device parts 2 of simulated smoking devices, such as cartridges 3 of electronic cigarettes. It will be clear to the skilled person that the device parts 2 of this system 1 can also relate to simulated smoking devices which are completely constructed but on which a further processing step (such as testing) will be applied before they are sold.

The system 1 comprise a processing station 4 to perform a processing operation on each of the device parts 2 of a batch 5 of device parts 2, which batch 5 has a batch number of device parts 2 being larger than one. In the shown situation, the batch number is ten.

An evaluation station 6 is provided to evaluate the result of the processing operation on each device part 2 of the batch 5, which evaluation station 6 is configured to provide an evaluation signal for each device part 2 of the batch 5.

A transport device 7 moves the device parts 2 of the batch 5 along a production trajectory 8 (see FIG. 4C), which production trajectory 8 extends through the processing station 4, the evaluation station 6 and an isolating station 9.

The system 1 comprises a controller 10 which is via communication lines 100 in communication with the transport device 7, the processing station 4, the evaluation station 6, the isolating station 9, a fluid pressure device 48 and a user interface 23.

The transport device 7 is configured to position the processed device parts 2 of the batch 5 in an isolating number of isolating positions 11 located in an isolating trajectory part 12 of the production trajectory 8, which isolating trajectory part 12 extends through the isolating station 9 (see the FIGS. 4B and C).

The isolating station 9 comprises a gripper 13 having gripping members 14 defining a gripping number of gripping positions 15 of the gripper 13 (see the FIGS. 9A-C). The gripper 13 is configured to grip with the gripping members 14 device parts 2 located in the gripping positions 15.

The isolating station 9 comprises a gripper mover 16 configured to move the gripper 13 from an engaging position 17 into a rejecting position 18, and vice versa (see the FIGS. 5A-D). In the engaging position 17 of the gripper 13, the device parts 2 of the batch 5 located in the isolating positions 11 are also located in the gripping positions 15 of the gripper 13. The rejecting position 18 of the gripper 13 is located at a rejecting distance 19 from the engaging position 17 and allows the gripper 13 to discharge gripped device parts 2 into a rejection area 20.

The controller 10 is configured to determine on the basis of the evaluation signals on which of the device parts 2 of the batch 5 located in the isolating positions 11 the processing station 4 has not correctly carried out the processing operation.

The isolating station 9 is configured to grip with the gripper 13 and based on the determination of the controller 10 one or more device parts 2 of the batch 5 located in the isolating positions 11 on which the processing operation has not been carried out correctly by the processing station 4 and to discharge said gripped one or more device parts 2 into the rejection area 20.

The gripper mover 16 is configured to also move the gripper 13 from the engaging position 17 into a testing position 21, and vice versa (see the FIGS. 6A-G). The testing position 21 is located at a sample distance 22 from the engaging position 17 and differs from the rejecting position 18.

The system 1 is provided with the user interface 23 allowing a user to select one of the device parts 2 of the batch 5. The user interface 23 is in communication with the controller 10 and configured to provide a selection signal.

The controller 10 is configured to determine on the basis of the selection signal which one of the device parts 2 of the batch 5 has been selected via the user interface 23. The isolating station 9 is configured to grip with the gripper 13 and based on the determination of the controller 10 the one of the device parts 2 of the batch 5 being selected via the user interface 23 and located in one of the isolating positions 11 in order to positon said gripped device part in a sample position 24.

The gripper 13 is configured to position the gripped device part being selected via the user interface 23 in the sample position 24 while the gripper 13 is positioned in the testing position 21.

The isolating station 9 does not only allow that device parts 2 on which the processing operation has not been carried out correctly are rejected, but also that a sample can be taken to independently check if the processing station 4 and the evaluation station 6 are operating correctly. The isolating station 9 allows this in an efficient manner while having a simple construction. In addition, it is also possible to check the sample which has been taken by the isolating station 9 on other characteristic.

The processing station 4 is a filling station 49 to discharge a predetermined amount of fluid in each of the device parts 2 of the batch 5 of device parts 2. The evaluation station 6 is configured to check a filling characteristic of each device part of the batch 5. More specifically, the evaluation station 6 is a weighing station 50 to individually weigh the device parts 2 filled by the filling station 49, which weighing station 50 provides a measurement signal for each of the device parts 2, and the controller 10 is configured to determine if the predetermined amount of fluid has been discharged in each of the device parts 2 on the basis of the measurement signals.

FIG. 2 shows a view in perspective of the system 1 of FIG. 1. The system 1 comprises a safety cover 35 forming a safety boundary 36 between a system area 37 in which the transport device 7, the processing station 4, the evaluation station 6, and the isolating station 9 are located, and a user area 38. The safety cover 35 comprises a sample opening 39 through which a sample device 31 extends. FIG. 3 shows the same system 1 without the safety cover 35.

FIG. 4A schematically shows a top view of the system 1 of FIG. 1. The transport device 7 comprises ten transport units 70A-J which together transport the device parts 2 along the production trajectory 8. The transport device 7 moves the device parts 2 along the production trajectory 8 in an intermittent manner. The intermittent manner in which transport device 7 moves the device parts 2 along the production trajectory 8 corresponding to the batch number of the batch 5 of device parts 2. FIG. 4B shows the batches 5 of devices parts positioned one after the other along the production trajectory 8. FIG. 4C shows the production trajectory 8 and the isolating trajectory part 12.

The FIGS. 5A-D show views in perspective of the isolating station 9 of the system 1 of FIG. 1.

In FIG. 5A, the processed device parts 2 of the batch 5 are positioned in the isolating number of isolating positions 11 located in the isolating trajectory part 12 of the production trajectory 8. The isolating number of the isolating positions 11 corresponds to the batch number of the batch 5 of device parts 2.

In FIG. 5B, the gripper 13 is moved with the gripper mover 16 into the engaging position 17, due to which the device parts 2 of the batch 5 located in the isolating positions 11 are also located in the gripping positions 15 of the gripper 13 (see also FIG. 9B). The gripping number of the gripping positions 15 of the gripper 13 corresponds to the isolating number. The controller 10 has determined on the basis of the evaluation signals on which of the device parts 2 of the batch 5 located in the isolating positions 11 the processing station 4 has not correctly carried out the processing operation. The isolating station 9 grips with the gripper 13 and based on the determination of the controller 10 two device parts 2 of the batch 5 located in the isolating positions 11 on which the processing operation has not been carried out correctly by the processing station 4 to discharge said gripped device parts 2 into the rejection area 20. The movement of the gripper 13 towards the rejection area 20 is shown in FIG. 5C. The transport device 7 moves the device parts 2 which are not gripped by the gripper 13 further along the production trajectory 8.

In FIG. 5D, the gripper 13 is located in the rejecting position 18. The rejection position of the gripper 13 is located at a rejecting distance 19 from the engaging position 17 and allows the gripper 13 to discharge gripped device parts 2 into a rejection area 20. The gripper 13 will release the gripped device parts 2 to discharge them in the rejection area 20.

In FIG. 6A, the processed device parts 2 of the batch 5 are positioned in the isolating number of isolating positions 11 located in the isolating trajectory part 12 of the production trajectory 8. One of the isolating positions 11 (in this case the fifth isolating position) defines a predetermined selecting position 25. This means that the sample taking indicated via the user interface 23 will take place at the predetermined selection position.

The controller 10 and the transport device 7 are configured to position the one of the device parts 2 being selected via the user interface 23 in the predetermined selecting position 25. The FIGS. 6F and G show how other device parts 2 selected via the user interface 23 are positioned in the predetermined selecting position 25.

The isolating station 9 is configured to grip with the gripper 13 the one of the device parts 2 of the batch 5 located in the predetermined selecting position 25 and being selected via the user interface 23 in order to positon said gripped device part 2 in the sample area. The gripping of said device part located in the predetermined selecting position 25 is shown in FIG. 6B. In FIG. 6C, the gripper 13 and the gripped device part is moving towards the sample position 24. The gripper 13 has arrived at the testing position 21 in FIG. 6D1. The same situation is shown at a different viewing angle in FIG. 6D2. In the FIGS. 6E1 and 6E2, the gripper 13 has released its grip on the device part in order to position it in the sample position 24. The transport device 7 moves the device parts 2 which are not gripped by the gripper 13 further along the production trajectory 8.

The directions of movement of the gripper 13 between and into the engaging position 17 and the rejecting position 18 and between and into the engaging position 17 and the testing position 21 all extend in a virtual flat plane 27 (see the FIGS. 4A and C). The engaging position 17, the rejecting position 18, the engaging position 17 and the sample position 24 are located in the virtual flat plane 27. The virtual flat plane 27 is located at a fixed position along the production trajectory 8. This means that the isolating station 9 is not moved along the production trajectory 8.

The transport device 7 is configured to hold the device parts 2 of the batch 5 during the movement along the production trajectory 8 in a predetermined orientation 29, more specifically in an upright orientation. The gripper 13 is configured to hold the gripped device parts 2 located in the gripping positions 15 in the predetermined orientation 29. The gripper mover 16 is configured to move the gripper 13 between the engaging position 17 and the testing position 21 while keeping the gripped device part located in the gripping position and being selected via the user interface 23 in the predetermined orientation 29. The gripper mover 16 is configured to, when located in the testing position 21, position the gripped device part 2 located in the gripping position 15 and being selected via the user interface 23 in the sample position 24 while keeping said device part in the predetermined orientation 29. The gripper mover 16 is configured to move the gripper 13 between the engaging position 17 and the rejecting position 18 while keeping the gripped device parts 2 located in the gripping positions 15 in the predetermined orientation 29.

FIG. 7A shows the same situation as the FIGS. 6D1 and 6D2 at yet another angle. The FIG. 7B shows the situation of the FIGS. 6E1 and 6E2. The sample position 24 is defined by a part holder 32 of a sample device 31 located in a retracted position 33. The part holder 32 of the sample device 31 is configured to hold the device part 2. The sample device 31 is configured to move the part holder 32 from the retracted position 33 (see FIG. 7B) into an extended position 34 (see FIG. 7C), and vice versa.

As made clear in the FIGS. 8A and B, the part holder 32 located in the retracted position 33 is located in the system area 37 and the part holder 32 located in the extended position 34 is located in the user area 38.

The part holder 32 is configured to hold the device part in the predetermined orientation 29. The sample device 31 is configured to move the part holder 32 from the retracted position 33 into the extended position 34 while keeping the device part held by the part holder 32 in the predetermined orientation 29.

The gripper 13 is shown in detail in the FIGS. 9A-C. Each gripping position of the gripper 13 is located between one of the gripping members 14 and an associated support surface 40. Each gripping member 14 comprises a pushing surface 41 which is movable from a receiving position 42 at a receiving distance 43 from its associated support surface 40 into a pushing position 44 at a smaller pushing distance 45 from its associated support surface 40, and vice versa.

The gripper 13 is configured to receive the device parts 2 of the batch 5 located in the isolating positions 11 when the pushing surfaces 41 of the gripping members 14 are located in the receiving position 42 and to grip the device parts 2 of the batch 5 located in the isolating positions 11 when the pushing surfaces 41 of the gripping members 14 are located in the pushing position 44. The gripper 13 clamps device parts 2 between gripping members 14 with the pushing surfaces 41 located in the pushing position 44 and the associated support surfaces 40. The associated support surfaces 40 partly surround the device parts 2.

Each gripping member 14 comprises a bellow 46 having an exterior surface 47 which forms the pushing surface 41 of said gripping member 14. The system 1 comprises a fluid pressure device 48 connected to the bellows 46 to individually adjust a fluid pressure in the bellows 46 in order to move the pushing surfaces 41 of the bellows 46 from the receiving position 42 into the pushing position 44, and vice versa. The fluid pressure device 48 is controlled by the controller 10. The fluid pressure device 48 is via fluid ducts 101 connected to fluid connectors 56 of the gripper 13.

The device part 2 is a cartridge 3 and shown in detail in the FIGS. 10A and B. The device parts 2 of the batch 5 comprise a fluid chamber 51 to hold the fluid 57 and a filling opening 52 having an open connection with the fluid chamber 51 and an surrounding area 54 of the device part 2. The filling opening 52 is located at an upper part 55 of the device part 2.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather, to provide an understandable description of the invention.

The terms “a” or “an”, as used herein, are defined as one or more than one. The term plurality, as used herein, is defined as two or more than two. The term another, as used herein, is defined as at least a second or more. The terms including and/or having, as used herein, are defined as comprising (i.e., open language, not excluding other elements or steps). Any reference signs in the claims should not be construed as limiting the scope of the claims or the invention.

It will be apparent to those skilled in the art that various modifications can be made to the system without departing from the scope as defined in the claims.

1-26. (canceled)

27. A system for processing device parts of simulated smoking devices, such as cartridges of electronic cigarettes, said system comprising:
a processing station to perform a processing operation on each of the device parts of a batch of device parts, which batch has a batch number of device parts being larger than one,
an evaluation station to evaluate the result of the processing operation on each device part of the batch, which evaluation station is configured to provide an evaluation signal for each device part of the batch,
a transport device to move the device parts of the batch along a production trajectory, which production trajectory extends through the processing station, the evaluation station and an isolating station,
a controller which is in communication with the evaluation station and the isolating station, wherein:
the transport device is configured to position the processed device parts of the batch in an isolating number of isolating positions located in an isolating trajectory part of the production trajectory, which isolating trajectory part extends through the isolating station,
the isolating station comprises a gripper having gripping members defining a gripping number of gripping positions of the gripper,
the gripper is configured to grip with the gripping members device parts located in the gripping positions,
the isolating station comprises a gripper mover configured to move the gripper from an engaging position into a rejecting position, and vice versa,
in the engaging position of the gripper, the device parts of the batch located in the isolating positions are also located in the gripping positions of the gripper,
the rejecting position of the gripper is located at a rejecting distance from the engaging position and allows the gripper to discharge gripped device parts into a rejection area,
the controller is configured to determine on the basis of the evaluation signals on which of the device parts of the batch located in the isolating positions the processing station has not correctly carried out the processing operation,
the isolating station is configured to grip with the gripper and based on the determination of the controller one or more device parts of the batch located in the isolating positions on which the processing operation has not been carried out correctly by the processing station and to discharge said gripped one or more device parts into the rejection area,
the gripper mover is configured to also move the gripper from the engaging position into a testing position, and vice versa,
the testing position is located at a sample distance from the engaging position and differs from the rejecting position,
the system comprises a user interface allowing a user to select one of the device parts of the batch, which user interface is in communication with the controller and configured to provide a selection signal,
the controller is configured to determine on the basis of the selection signal which one of the device parts of the batch has been selected via the user interface, and
the isolating station is configured to grip with the gripper and based on the determination of the controller the one of the device parts of the batch being selected via the user interface and located in one of the isolating positions in order to positon said gripped device part in a sample position.

28. The system according to claim 27, wherein:
the controller is in communication with the transport device,
one of the isolating positions defines a predetermined selecting position,
the controller and the transport device are configured to position the one of the device parts being selected via the user interface in the predetermined selecting position, and
the isolating station is configured to grip with the gripper the one of the device parts of the batch located in the predetermined selecting position and being selected via the user interface in order to positon said gripped device part in the sample area.

29. The system according to claim 27, wherein the directions of movement of the gripper between and into the engaging position and the rejecting position and between and into the engaging position and the testing position all extend in a virtual flat plane.

30. The system according to claim 29, wherein the engaging position, the rejecting position, the engaging position and the sample position are located in the virtual flat plane

31. The system according to claim 29, wherein the virtual flat plane is located at a fixed position along the production trajectory.

32. The system according to claim 27, wherein the transport device is configured to hold the device parts of the batch during the movement along the production trajectory in a predetermined orientation, such as in an upright orientation.

33. The system according to claim 32, wherein the gripper is configured to hold the gripped device parts located in the gripping positions in the predetermined orientation.

34. The system according to claim 32, wherein the gripper mover is configured to move the gripper between the engaging position and the testing position while keeping the gripped device part located in the gripping position and being selected via the user interface in the predetermined orientation.

35. The system according to claim 32, wherein the gripper mover is configured to, when located in the testing position, position the gripped device part located in the gripping position and being selected via the user interface in the sample position while keeping said device part in the predetermined orientation.

36. The system according to claim 32, wherein the gripper mover is configured to move the gripper between the engaging position and the rejecting position while keeping the gripped device parts located in the gripping positions in the predetermined orientation.

37. The system according to claim 27, wherein:
the system comprises a sample device having a part holder to hold one of the device parts,
the sample device is configured to move the part holder from a retracted position into an extended position, and vice versa,
the sample position is defined by the part holder located in the retracted position,
the system comprises a safety cover forming a safety boundary between a system area in which the transport device, the processing station, the evaluation station, and the isolating station are located, and a user area,
the safety cover comprises a sample opening through which the sample device extends, and
the part holder located in the retracted position is located in the system area and the part holder located in the extended position is located in the user area.

38. The system according to claim 37, wherein the part holder is configured to hold the device part in the predetermined orientation.

39. The system according to claim 37, wherein the sample device is configured to move the part holder from the retracted position into the extended position while keeping the device part held by the part holder in the predetermined orientation.

40. The system according to claim 27, wherein:
each gripping position of the gripper is located between one of the gripping members and an associated support surface, and
each gripping member comprises a pushing surface which is movable from a receiving position at a receiving distance from its associated support surface into a pushing position at a smaller pushing distance from its associated support surface, and vice versa.

41. The system according to claim 40, wherein the gripper is configured to receive the device parts of the batch located in the isolating positions when the pushing surfaces of the gripping members are located in the receiving position and to grip the device parts of the batch located in the isolating positions when the pushing surfaces of the gripping members are located in the pushing position.

42. The system according to claim 27, wherein the transport device moves the device parts along the production trajectory in an intermittent manner.

43. The system according to claim 27, wherein:
the isolating number of the isolating positions corresponds to the batch number of the batch of device parts, and
the gripping number of the gripping positions of the gripper corresponds to the isolating number.

44. The system according to claim 27, wherein:
the processing station is a filling station to discharge a predetermined amount of fluid in each of the device parts of the batch of device parts,
the evaluation station is configured to check a filling characteristic of each device part of the batch.

45. The system according to claim 44, wherein the evaluation station is a weighing station to individually weigh the device parts filled by the filling station, which weighing station provides a measurement signal for each of the device parts, and the controller is configured to determine if the predetermined amount of fluid has been discharged in each of the device parts on the basis of the measurement signals.

46. The system according to claim 27, wherein the device parts of the batch comprise a fluid chamber to hold the fluid and a filling opening having an open connection with the fluid chamber and an surrounding area of said device parts.
